(19) United States
(12) Patent Application Publication
(10) Pub. No.: US 2011/0015831 A1
(43) Pub. Date: Jan. 20, 2011

(54) APPLICATION RATE SYSTEM FOR A FARM IMPLEMENT

(75) Inventor: Darrell D. Farmer, Eagle, NE (US)

Correspondence Address: ZARLEY LAW FIRM P.L.C., CAPITAL SQUARE, 400 LOCUST, SUITE 200, DES MOINES, IA, 50309-2350, US

(73) Assignee: LOUP ELECTRONICS, INC., Lincoln, NE (US)

(21) Appl. No.: 12/504,881

(22) Filed: Jul. 17, 2009

(51) Int. Cl. G06F 19/00

(52) U.S. Cl. 701/50

(57) ABSTRACT

An application rate system having a first controller mounted in a cab of a tractor. An implement, having a hopper, is connected to the tractor. Attached to the hopper is a scale for measuring the weight of material disposed in the hopper. Connected to the scale is a second controller. The second controller sends information about the measured weight of the material in the hopper to the first controller, and the first controller calculates the rate of application based upon the change in the measured weight in relation to the area covered by the tractor and the implement.

### BACKGROUND OF THE INVENTION

The invention is directed toward a system for determining the application rate of a material to a field and more particularly a system for determining the application rate based upon the weight of material.

Scales for determining the weight of material to be distributed are well known in the art. This information is used to calculate the amount of seed or fertilizer applied to the field by subtracting the current weight from the original weight and dividing the number by the number of acres covered. The number of acres covered is typically determined by a separate monitoring device or estimated. As a result, application rates are often inaccurate. Either a mathematical error is made when calculating, the acres covered value is inaccurate, or the scale value was taken over too short a period and may be inaccurate. As a result, a need exists for a system that addresses these deficiencies.

An objective of the invention is to provide a system that more accurately calculates an application rate.

A still further objective of this invention is to provide a system that more easily calculates an application rate.

These and other objectives will be apparent to those skilled in the art based on the following disclosure.

### SUMMARY OF THE INVENTION

An application rate system having a controller mounted in a cab of a tractor or to an implement. The implement, having a hopper connected to the tractor. Attached to the hopper is a scale for measuring the weight of material disposed in the hopper. Connected to the scale is the controller. The controller receives information about the measured weight of the material in the hopper and calculates the rate of application based upon the change in the measured weight in relation to the area covered by the tractor and the implement.

### BRIEF DESCRIPTION OF THE DRAWINGS

FIG. 1 is a side view of a tractor and implement; and

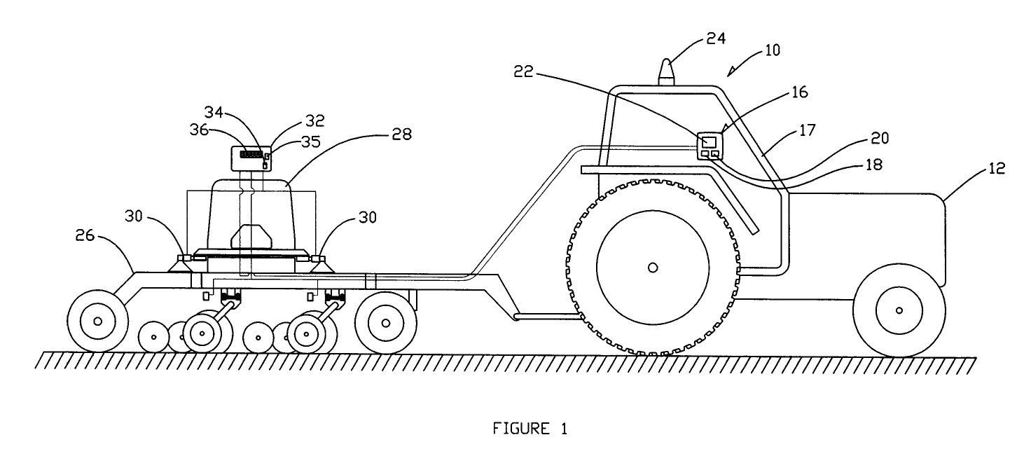

FIG. 2 is a schematic of an application rate system.

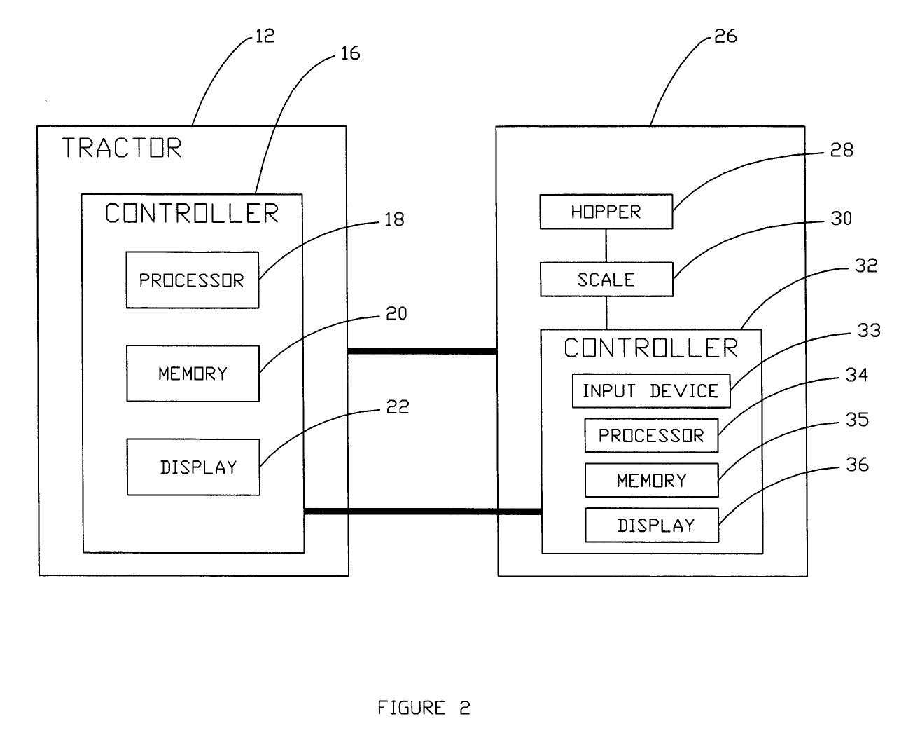

### DETAILED DESCRIPTION OF THE PREFERRED EMBODIMENTS

Referring to the Figures, the scale system 10 includes a tractor 12 having a cab 14. Mounted within the cab 14 is a controller 16 which has a processor 18, a memory 20, and a display 22. The controller 16 is connected to a plurality of sensors on the tractor 12 to monitor the operation of the tractor 12. In one embodiment, the controller 16 is connected to a global positioning system 24 for use with a mapping system.

Connected to the tractor 12 is an implement 26. The implement 26 is of any type such as a grain drill, seed planter, fertilizer sprayer, or the like. Mounted on the implement is a hopper 28 for receiving seed or fertilizer. Connected to the hopper 28 is a scale 30. The scale 30 is of any type known in the art and preferably is a load cell containing a strain gauge measuring system. Connected to the scale 30 is a controller 32 having an input device 33, a processor 34, a memory 35, and a display 36. The controller 32, is connected to controller 16 either electrically or wirelessly by way of an RS232 communication channel or the like.

In operation, the density of the material to be distributed is input via the input device 33 into controller 16 and/or 32. For example the number of seeds per pound is input into the controller 32. Once density is input, material is placed in hopper 28 and an initial weight is determined by scale 30. The information of the initial weight is transmitted to controller 16 and/or 32 where in one embodiment it is stored in the memory 35 and shown on display 36. The initial information is also sent to controller 16 where it is stored in memory 20 and preferably shown on display 22.

In one example, once activated or once distribution of material begins, the weight of the material in the hopper 28 is determined by the scale 30 and sent initially to controller 32 and then to controller 16. Controller 32 continuously transmits live information to controller 16. Controller 16 samples this information periodically when the current sensed speed is below a predetermined threshold. This sampled information is then stored in memory 20. This is done so that inaccurate weight numbers detected by the scale 30 due to G-forces generated by machine movement are screened and do not create false calculations. In a preferred embodiment the current sensed speed must drop to 2 MPH or below before controller 16 begins sampling. Controller 16 continues sampling every 10 seconds until the current sensed speed exceeds 2 MPH. By using the current sensed speed as the sampling threshold, the need for lift switches or other activation devices is obviated.

The area covered is determined by controller 16 and/or 32 from the GPS system 24 or another distance measurement device such as a wheel pulse counter, radar or the like. In one embodiment the current sensed speed threshold is used such that when the current sensed speed drops to the sampling threshold or below, controller 16 and/or 32 begins accumulating acres which are calculated by processor 18 based upon user entered implement swath width stored in memory 20 of controller 16 and/or 32. Acres continue to be accumulated until the sampling threshold is exceeded.

Once the weight information and area covered is received at controller 16 and/or 32, the current weight information is subtracted from the original weight and divided by the area covered to determine the rate of application. The rate of application is then shown on display 22 and/or 36. The rate of application is shown in pounds (KG) per acre (Hectare) or using the material density, seeds per acre. This is particularly of value where application rates and seed counts are too small to be accurately measured by available seed counting technology.

In addition, information about the area left to be covered is calculated and displayed. For example, the processor 18 calculates the amount of seed left in the hopper 28 and based upon the calculated application rate, the processor determines the number of acres that can be covered based upon the current material in the hopper. This information is then shown on display 22 and sent to and shown on display 36. Having this information would permit a user to be resupplied on a timely basis. Alternatively, the user could increase or decrease the application rate to ensure that there is sufficient seed to cover the remaining area.

What is claimed is:

1. An application rate system, comprising:
a controller mounted to a tractor;
an implement connected to the tractor;
a hopper mounted to the implement for holding material to be distributed;
a scale attached to the hopper for determining a weight of material in the hopper;
wherein the controller calculates the application rate based upon a change in weight measured in relation to the area covered.

2. The application rate system of claim 1, wherein the first controller determines an area to be covered based upon the change in weight measured and the calculated application rate.

3. The application rate system of claim 1 wherein the second controller has an input device.

4. The application rate system of claim 3 wherein seed density information is input into the first controller.

5. The application rate system of claim 1 wherein the area covered is determined by a global positioning system connected to the first controller.

6. An application rate system, comprising:
a controller mounted to an implement that is connected to a tractor;
a hopper mounted to the implement for holding material to be distributed;
a scale attached to the hopper for determining a weight of material in the hopper;
wherein the controller calculates the application rate based upon a change in weight measured in relation to the area covered.

7. The application rate system of claim 6, wherein the first controller determines an area to be covered based upon the change in weight measured and the calculated application rate.

8. The application rate system of claim 6 wherein the second controller has an input device.

9. The application rate system of claim 8 wherein seed density information is input into the first controller.

10. The application rate system of claim 6 wherein the area covered is determined by a global positioning system connected to the first controller.
